(19) United States
(12) Patent Application Publication
(10) Pub. No.: US 2024/0320403 A1
(43) Pub. Date: Sep. 26, 2024

(54) LATTICE CELL MODIFICATIONS

(71) Applicant: Hewlett-Packard Development Company, L.P., Spring, TX (US)

(72) Inventors: Randall Dean WEST, Vancouver, WA (US); Pierre Joseph KAISER, Vancouver, WA (US); Luis BALDEZ, Vancouver, WA (US)

(21) Appl. No.: 18/575,851

(22) PCT Filed: Jul. 14, 2021
(86) PCT No.: PCT/US2021/041515

§ 371 Date: Dec. 31, 2023

(51) Int. Cl. G06F 30/27; G06F 113/10

(52) U.S. Cl. CPC G06F 30/27; G06F 2113/10

(57) ABSTRACT

In some examples, a system receives a representation of a lattice cell and information representing a target modified behavior of the lattice cell. The representation of the lattice cell including an arrangement of beams of the lattice cell. The system generates a modified lattice cell based on the representation of the lattice cell and the information, where the modified lattice cell includes the arrangement of the beams and an added behavior adjustment structure that is connected to a selected beam of the arrangement of the beams.

### BACKGROUND

An additive manufacturing machine can be used to generate a lattice structure. In some examples, a compressible layer used in consumer and sporting goods, in vehicles, and so forth, can have a lattice structure. In other examples, other products can include lattice structures.

Additive manufacturing machines produce three-dimensional (3D) objects by accumulating layers of build material, including a layer-by-layer accumulation and solidification of the build material patterned from computer aided design (CAD) models or other digital representations of physical 3D objects to be formed. A type of an additive manufacturing machine is referred to as a 3D printing system. Each layer of the build material is patterned into a corresponding part (or parts) of the 3D object.

### BRIEF DESCRIPTION OF THE DRAWINGS

Some implementations of the present disclosure are described with respect to the following figures:

FIG. 1 is a block diagram of an arrangement that includes a lattice cell modification engine according to some examples;

FIGS. 2A and 2B illustrate an initial lattice cell and a modified lattice cell, respectively, where the modified lattice cell is generated by the lattice cell modification engine according to some examples.

FIG. 3 illustrates different states of a lattice structure and an associated force profile, according to some examples;

FIG. 4 is a block diagram of a system that includes a lattice cell modification program, according to some examples.

FIGS. 5A-5C illustrate different lattice cells with different behavior adjustment structures, according to some examples.

FIG. 6 is a block diagram of a system that includes a machine learning model according to some examples.

FIG. 7 is a block diagram of a storage medium storing machine-readable instructions according to some examples; and

FIG. 8 is a flow diagram of a process of generating a modified lattice cell according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A lattice structure refers to a physical structure having an interlaced pattern of connecting members that are interconnected with one another. The connecting members can be referred to as “beams.” A beam can refer to a generally elongated member within the lattice structure. The beam can be straight, can be curved, or can have a more complex shape than merely being straight or curved. A lattice structure can include an arrangement of unit cells, where the unit cells are repeated and interconnected to one another to define a lattice. In some cases, the arrangement of unit cells in the lattice structure can include a single layer of lattice cells or multiple layers of lattice cells. A “unit cell” of a lattice structure includes an arrangement of beams.

In the ensuing discussion, a “unit cell” of a lattice structure is referred to as a “lattice cell.” A lattice cell is repeated to provide multiple instances of the lattice cell that are then interconnected to represent a 3D object that is to be built.

An additive manufacturing machine can be used to build a lattice structure that includes a repeating or periodic arrangement of lattice cells. A digital representation (e.g., a CAD file) of a 3D object to be built is provided to the additive manufacturing machine to allow the additive manufacturing to build the 3D object on a layer-by-layer basis. The digital representation of a target 3D object that includes a lattice structure includes an arrangement of the lattice cells that make up the lattice structure. The digital representation specifies an interconnection of the lattice cells to form the target 3D object. The additive manufacturing machine builds the arrangement of lattice cells on a layer-by-layer basis.

Building a lattice structure with an additive manufacturing machine can allow for better control of mechanical characteristics of the lattice structure than possible with other manufacturing techniques. For example, a digital representation of the lattice structure can be adjusted to change mechanical properties (e.g., compressibility, stiffness, density, mechanical strength, kinetic energy dissipation, kinetic energy return, deceleration, etc.) of the lattice structure.

In some examples, a lattice structure is compressible based on the material used to form the lattice structure, where the material can include a thermoplastic polyurethane material, thermoplastic polyamide, or another elastomeric material. In other examples, materials used to form lattice structures can include polypropylene, polyamide 11, polyamide 12, a metal, and so forth. In other examples, a lattice structure can exhibit other types of deformations, such as bending, pivoting, and so forth.

A lattice structure can be defined by use of a CAD tool or another program executed in a computer system when creating a digital representation of a 3D object to be built.

Kinetic energy dissipation can refer to how the lattice structure dissipates kinetic energy experienced by the lattice structure due to displacement of the lattice structure, such as due to a force applied by another object (e.g., an anatomical part of a human, a tool, or any other type of object). “Displacement” of a lattice structure can refer to movement of a first portion of the lattice structure relative to a second portion of the lattice structure. For example, a compressible lattice structure on a support surface can be compressed by application of a force against a side (or multiple sides) of the lattice structure that is sitting on the support surface. The compression of the lattice structure causes movement of one portion of the lattice structure relative to another portion of the lattice structure. For example, beams that make up the lattice structure can be brought into closer proximity to each other as a result of the compression of the lattice structure.

Kinetic energy return can refer to a response of the lattice structure to kinetic energy experienced by the lattice structure due to displacement of the lattice structure. For example, a compressed lattice structure that is compressed by an applied force (which imparts kinetic energy on the lattice structure to compress the lattice structure) will cause the lattice structure to oppose the applied force. The opposing force applied by the lattice structure during compression is an example of a kinetic energy return.

Deceleration can refer to a characteristic of the lattice structure in which the lattice structure when initially compressed may exhibit larger acceleration due to greater velocity per unit time, and the lattice structure may subsequently exhibit a reduction in acceleration (i.e., deceleration) when the lattice structure is compressed further.

Generally, a lattice cell is associated with a mechanical property (such as any of the example mechanical properties listed further above) that is based on the arrangement of beams, dimensions of the beams, and a material(s) of the beams making up the lattice cell. In lattice structures that are considered “high displacement,” the lattice structures may perform as intended (based on the mechanical properties of the lattice cell) when a displacement of the lattice structure does not exceed a specified threshold. A “high displacement” lattice structure can refer to a lattice structure where displacement by greater than 10% (or another percentage) relative to the non-displaced size of the lattice structure during a target use of the lattice structure would not cause the lattice structure to exhibit an anomalous behavior. For example, a seat cushion for a vehicle may provide acceptable support for a human driver or passenger during normal use associated with the seat cushion, during which the human driver or passenger sits on the seat cushion and causes compression of the seat cushion. However, in some cases, an excessive force (e.g., force applied by a blunt object) may be applied on the seat cushion that can cause damage to the seat cushion due to excessive compression. This damage can be due to a displacement of the lattice structure that exceeds the specified threshold.

If displacement of the lattice structure goes beyond the specified threshold, then damage to the lattice structure can result. For example, a seat cushion that has been exposed to excessive force that caused the displacement of the lattice structure making up the seat cushion to exceed the specified threshold can result in the seat cushion no longer providing acceptable or comfortable support for a user.

In accordance with some implementations of the present disclosure, a property adjustment structure is added to a lattice cell in an automated manner based on various inputs, which can include a representation of an original lattice cell and a profile representing a target modified behavior (discussed further below) for the lattice cell. In some examples, adding the property adjustment structure (according to the target modified behavior) to the lattice cell allows for an adjustment of a mechanical property (or multiple mechanical properties) of the lattice cell such that a lattice structure built using the lattice cell can withstand a large force applied to the lattice structure without damage. More generally, adding the property adjustment structure (according to the target modified behavior) to the lattice cell allows for a lattice structure built using the lattice cell to maintain its target property (or properties) under various conditions.

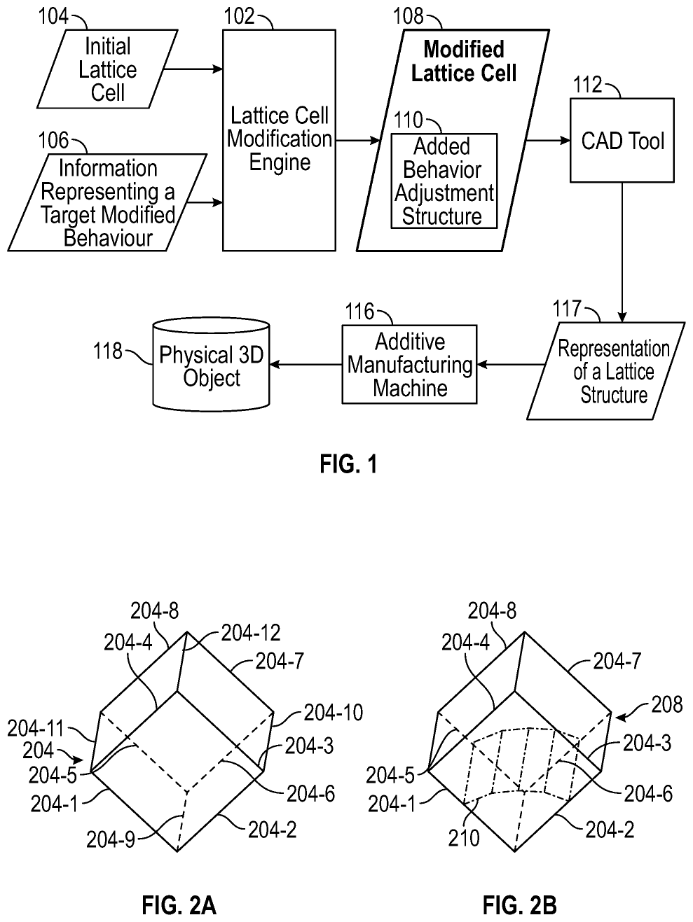

FIG. 1 is a block diagram of an example arrangement that includes a lattice cell modification engine 102 that is used to produce modified lattice cells according to some examples.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

The lattice cell modification engine 102 can be implemented using a computer or a collection of multiple computers. As discussed further below, the lattice cell modification engine 102 can include a program and/or a machine learning model.

The lattice cell modification engine 102 receives, as inputs, an initial lattice cell 104 and information 106 representing a target modified behavior. The initial lattice cell 104 provided as an input to the lattice cell modification engine 102 can be in the form of a file or any other representation of an arrangement of beams that make up the initial lattice cell 104.

An “initial” lattice cell can refer to a lattice cell that is provided as an input to the lattice cell modification engine 102 for purposes of modifying the lattice cell. The initial lattice cell 104 may be an original lattice cell, such as a lattice cell that is a according to a predefined template (among a collection of multiple lattice cell templates) that can be used by designers to generate lattice structures for building physical 3D objects according to the lattice cells. In other examples, the initial lattice cell 104 may be a lattice cell that was previously modified, such as by the lattice cell modification engine 102. This previously modified lattice cell may be subject to further modification by the lattice cell modification engine 102.

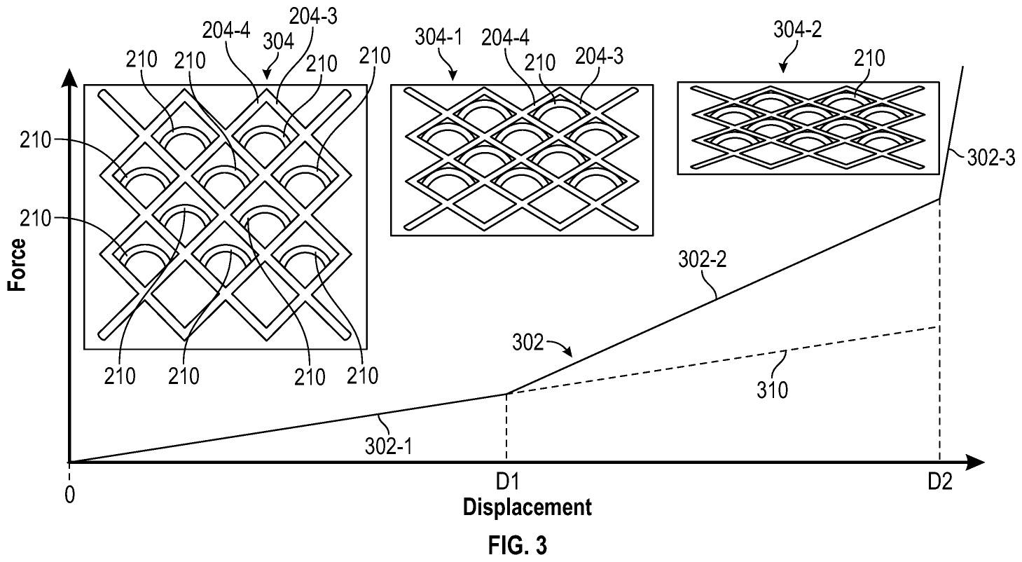

The information 106 representing the target modified behavior refers to information that specifies how a mechanical property of the initial lattice cell 104 is to change under a specified condition. For example, the property to be changed can include any or some combination of the following: compressibility (due to displacement), stiffness, density, mechanical strength, kinetic energy dissipation, kinetic energy return, deceleration, and so forth. An example of the information 106 representing the target modified behavior is discussed in connection with FIG. 3 below.

The condition under which the property change is to occur can include a force applied to the lattice cell, a temperature of an environment around the lattice cell, a pressure of an environment around the lattice cell, a humidity of an environment around the lattice cell, an electrical energy applied to the lattice cell, a magnetic field applied to the lattice cell, or any other input stimulus to which the initial lattice cell 104 may be subjected.

Based on the initial lattice cell 104 and the information 106 representing the target modified behavior, the lattice cell modification engine 102 generates a modified lattice cell 108, which can be in the form of a file or another representation of an arrangement of beams plus an added behavior adjustment structure 110.

The modified lattice cell 108 can include the arrangement of beams of the initial lattice cell 104, plus the added behavior adjustment structure 110 that is connected to a beam or multiple beams of the arrangement of beams of the initial lattice cell 104.

As used here, an “added behavior adjustment structure” can refer to any structure that is added to a lattice cell and connected to a beam or multiple beams of the lattice cell. The behavior adjustment structure 110 can have any of various different shapes, including in the form of a beam (straight or curved), a plate (flat or curved), a fork, a bumper, a tie, or any other type of structure.

Although reference is made to the added behavior adjustment structure 110 in the singular sense, note that the added behavior adjustment structure 110 can refer to a single structure or multiple structures that are added to the arrangement of beams of the initial lattice cell 104.

Once the modified lattice cell 108 is generated, the modified lattice cell 108 is provided as an input to a CAD tool 112. The CAD tool 112 can refer to any type of CAD tool used for producing a digital representation of a physical object. The CAD tool 112 can be an off-the-shelf CAD tool that is commercially available, an open source CAD tool, a proprietary CAD tool, and so forth.

Using the modified lattice cell 108, the CAD tool 112 can generate a lattice structure that includes multiple instances of the modified lattice cell 108 that are interconnected together.

The CAD tool 112 generates a representation 117 of the lattice structure. The representation of the lattice structure can be in the form of a CAD file, which is provided as an input to an additive manufacturing machine 116. The additive manufacturing machine 116 builds a physical 3D object 118 on a layer-of-layer basis based on the representation 117 of the lattice structure.

FIGS. 2A-2B show examples of an initial lattice cell 204 and a modified lattice cell 208, respectively. The initial lattice cell 204 is provided as an input to the lattice cell modification engine 102, which produces the modified lattice cell 208 based on the initial lattice cell 204 and according to the information 106 representing the target modified behavior.

In the example of FIG. 2A, the initial lattice cell 204 is generally in the form of a cube that has 12 beams that are interconnected together. The 12 beams are labeled as 204-1 to 204-12. In other examples, a lattice cell can have a different arrangement of beams to form different shapes. Also, in further examples, a lattice cell may include an inner core to which beams are connected.

The modified lattice cell 208 produced by the lattice cell modification engine 102 includes an added behavior adjustment structure 210, which is in the form of a curved plate according to some examples. The curved plate 210 is connected to the beams 204-1, 204-2, 204-5, and 204-6.

The curved plate 210 in the uncompressed state of the modified lattice cell 208 shown in FIG. 2B is spaced apart from the upper beams 204-3, 204-4, 204-7, and 204-8 (in the orientation of FIG. 2B).

However, as discussed further in connection with FIG. 3 below, when the modified lattice cell 208 is compressed, such as by a force applied on a side or multiple sides of the lattice cell 208, the curved plate 210 may touch the beams 204-3, 204-4, 204-7, in 204-8 once sufficient compression of the beams of the modified lattice cell 208 has occurred. The curved plate 210 when touching the beams resists further compression of the modified lattice cell 208, as depicted in FIG. 3.

FIG. 3 shows examples of different states of a lattice structure 304 that includes a repeating and interconnected arrangement (a pattern) of multiple instances of the modified lattice cell 208. Each instance of the modified lattice cell 208 in the lattice structure 304 includes a respective instance of the curved plate 210. The lattice structure 304 of FIG. 3 is shown as a two-dimensional (2D) view.

In FIG. 3, the lattice structure 304 is in an uncompressed state, a first compressed modified lattice structure 304-1 is a compressed version of the lattice structure 304 compressed by a first amount, and a second compressed modified lattice modified lattice structure 304-2 is a compressed version of the first compressed lattice structure 304-1 compressed by a further amount greater than the first amount.

FIG. 3 further shows curve 302 that represents a relationship between a force (vertical axis of the graph shown in FIG. 3) applied to the modified lattice cell 208 and a displacement (horizontal axis of the graph) that is experienced by the lattice structure 304. The curve 302 is an example of the information 106 representing the target modified behavior of FIG. 1.

In some examples, a force can be represented using a parameter such as stress, tension, or any other parameter that provides an indication of force applied on a lattice cell. A displacement of the lattice cell can be represented by a parameter such as strain, distance moved, and so forth.

Without the added behavior adjustment structure in the form of the curved plate 210 added in the modified lattice cell 208, a lattice structure formed using the initial lattice cell 204 would have a behavior represented by a line including a curve segment 302-1 and another segment 310 (in dashed profile in FIG. 3). Generally, the line including the curve segment 302-1 and the segment 310 represents how much displacement (compression) of the lattice structure formed using the initial lattice cell 204 would occur in response to an increase in the applied force.

An increase in the applied force would cause an increase in compression (and thus displacement) of the lattice structure formed using the initial lattice cell 204, until a displacement D2 is reached which may cause damage to the lattice structure formed using the initial lattice cell 204.

The lattice structure 304 formed with the modified lattice cell 208 that has the curved plate 210 exhibits a different behavior as represented by the curve 302, which includes the curve segment 302-1, a second curve segment 302-2, and a third curve segment 302-3. The presence of the curved plate 210 in each instance of the modified lattice cell 208 of the lattice structure 304 can serve to protect the lattice structure 304 from damage when the displacement D2 has been reached.

In the uncompressed state of the lattice structure 304 shown in FIG. 3, the upper (protruding) portion of the curved plate 210 is spaced apart from the upper beams 204-3 and 204-4 (and similarly from the upper beams 204-7 and 204-8 visible in FIG. 2B).

In the first segment 302-1 of the curve 302, the applied force is steadily increased to cause displacement (compression) of the lattice structure 304, to produce the first compressed lattice structure 304-1. A displacement value of 0 indicates no compression of the lattice structure 304.

When displacement of the lattice structure 304 reaches value D1, the upper portion of each curved plate 210 in the lattice structure 304-1 makes initial physical contact with the respective upper beams 204-3, 204-4, 204-7, and 204-8.

When the curved plate 210 of each modified lattice cell 208 in the lattice structure 304-1 makes initial contact with the respective upper beams 204-3, 204-4, 204-7, and 204-8, a larger force per unit displacement (represented by the second curve segment 302-2) would have to be applied (than the force applied per unit displacement in the first curve segment 302-1) to further compress the first compressed lattice structure 304-1.

The second segment 302-2 of the curve 302 represents an increased rate at which force is applied to cause further compression of the first compressed lattice structure 304-1.

Once the first compressed lattice structure 304-1 has been compressed by an amount corresponding to displacement D2, the second compressed lattice structure 304-2 results. In the state of the second compressed lattice structure 304-2, the curved plate 210 of each modified lattice cell 208 has been deformed and has reached a point where further compression of the second compressed lattice structure 304-2 would have to overcome the structural resistance provided by the curved plate 210 of each instance of the modified lattice cell 208 having reached a maximum deformed state. At this point, any further compression of the second compressed lattice structure 304-2 would involve use of an applied force per unit displacement represented by the third curve segment 302-3) that is larger than the force per unit displacement represented by the second curve segment 302-2.

Although the example of FIG. 3 shows the curve 302 as having linear curve segments 302-1, 302-2, and 302-3, in other examples, any or some of the curve segments 302-1, 302-2, and 302-3 may be non-linear, such as curved, exponential, and so forth.

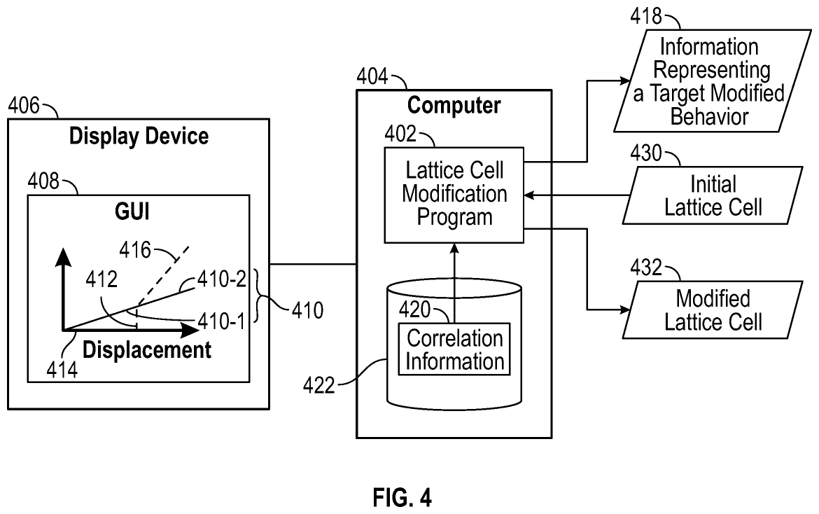

FIG. 4 shows an example in which the lattice cell modification engine 102 of FIG. 1 is in the form of a lattice cell modification program 402. The lattice cell modification program 402 can execute in a computer 404.

The computer 404 includes or is connected to a display device 406. The lattice cell modification program 402 can cause presentation of a graphical user interface (GUI) 408 that is displayed by the display device 406. The GUI 408 can present an initial curve 410 that represents a behavior of a lattice structure built using an initial lattice cell (without an added behavior adjustment structure). In some examples, the initial curve 410 can depict the relationship between force and displacement of the lattice structure built using the initial lattice cell.

The initial curve 410 (including curve segments 410-1 and 410-2) is user manipulatable in the GUI 408, using an input device of the computer 404. A user can adjust points of the initial curve 410. For example, the user can identify a point 412 on a displacement axis 414 at which the initial curve 410 is to be changed. For example, the user can specify in the GUI 408 that, starting at the point 412, an increased force per unit displacement is to be applied to cause further compression of a lattice structure, using control elements or input fields of the GUI 408. As an example, the user can enter a specific force per unit displacement (such as in an input field or as a selection from a dropdown menu) that is to be represented by a curve segment 416. The curve segment 416 and the curve segment 410-1 together make up a curve that represents a target modified behavior of a lattice cell that is different from the behavior represented by the initial curve 410 for the initial lattice cell.

Based on the user manipulation in the GUI 408, the lattice cell modification program 402 can generate information 418 representing a target modified behavior of a lattice cell (e.g., similar to 106 in FIG. 1). The information 418 representing the target modified behavior can be in the form of a force profile that correlates a parameter representing a force applied on a lattice cell to a displacement of the lattice cell.

The ensuing discussion refers to examples in which force profiles are used to represent target modified behaviors of lattice cells. Similar techniques can be applied with other types of information representing target modified behaviors of lattice cells.

A data repository 422 can store correlation information 420 that correlates different force profiles to respective different behavior adjustment structures (e.g., beams, plates, ties, forks, bumpers, etc., including variants of the foregoing formed with different dimensions and/or materials). The correlation information 420 may be populated by a human (or team of humans), for example. The correlation of different force profiles to respective different behavior adjustment structures can be based on studies by the human or team of humans based on how lattice structures with different behavior adjustment structures behave.

Once a force profile (an example of the information 418 representing the target modified behavior) is generated by the lattice cell modification program 402 based on a user manipulation in the GUI 408, the lattice cell modification program 402 can use the generated force profile to perform a lookup of the correlation information 420. The correlation information 420 can be in the form of a lookup table. The generated force profile can correspond to an entry of the lookup table.

In examples where the generated force profile does not correspond to any specific entry of the correlation information 420, the entry of the correlation information 420 that most closely matches the generated force profile can be selected. The corresponding entry of the correlation information 420 includes information specifying the respective behavior adjustment structure to add to an initial lattice cell 430 to generate a modified lattice cell 432.

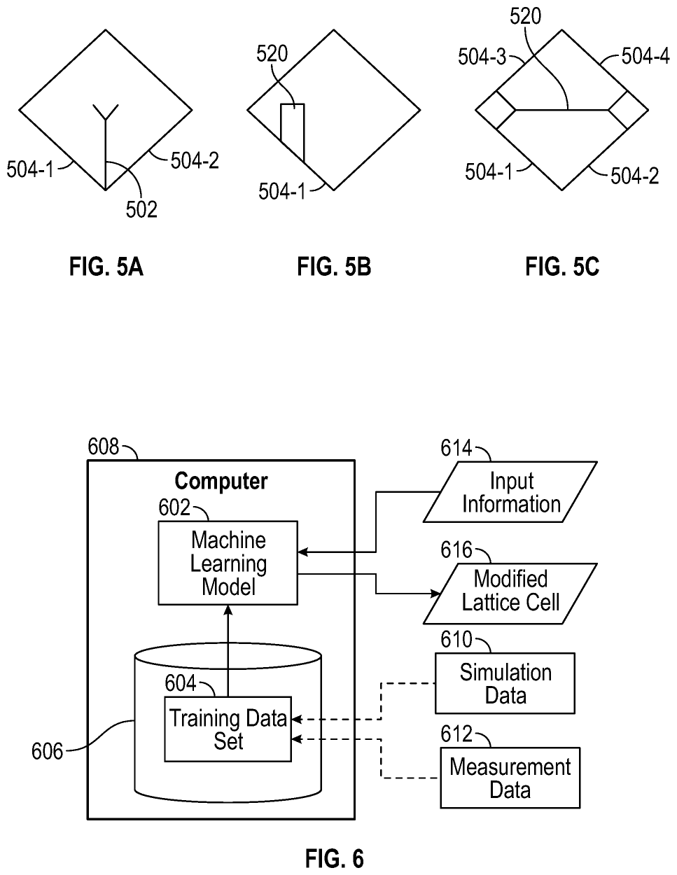

FIGS. 5A-5C show 2D views of examples of other types of behavior adjustment structures. FIG. 5A shows a fork 502 that is connected to an intersection of beams 504-1 and 504-2 of a lattice cell. The fork 502 is generally Y-shaped, and includes a first segment and two other segments extending from an end of the first segment.

FIG. 5B shows a bumper 510 connected to the beam 504-1 of the lattice cell.

FIG. 5C shows a tie 520 attached to beams 504-1, 504-2, 504-3, and 504-4 of the lattice cell.

In other examples, other types of behavior adjustment structures can be employed.

FIG. 6 shows another example of the lattice cell modification engine 102 of FIG. 1. In FIG. 6, the lattice cell modification engine 102 includes a machine learning model 602 that can be trained using a training data set 604. The training data set 604 is stored in a data repository 606.

The machine learning model 602 is executable by a computer 608.

Different machine learning models can be employed for different lattice cells. For example, a first lattice cell that is shaped as a cube with specific dimensions and/or materials can be associated with a first machine learning model, a second lattice cell that is shaped as a pyramid with specific dimensions and/or materials can be associated with a second machine learning model, and so forth.

Moreover, lattice cells having the same shape (e.g., cube, pyramid, etc.) but having different dimensions and/or materials can also be associated with respective different machine learning models.

A lattice cell has a specific configuration, which includes a specific arrangement of beams, dimensions (e.g., length and width) of the beams, materials of the beams, and so forth. More generally, different machine learning models can be employed for lattice cells of respective different configurations.

The training data set 604 is produced using either simulation data 610 or measurement data 612, or both.

The measurement data 612 is obtained by performing physical measurements of various properties of a lattice structure that has been built using a specific lattice cell of a given configuration. For example, for an applied force, a measurement can be made of a displacement of the lattice structure. As the force is increased, further measurements of displacements can be made.

To perform such measurements, multiple lattice structures formed with the specific lattice cell of a given configuration can be built, such as by an additive manufacturing machine. The multiple lattice structures built by the additive manufacturing machine can include different versions of the lattice cell of the given configuration, where the different versions employ different behavior adjustment structures. For example, a first version of the lattice cell of the given configuration can have a first behavior adjustment structure, a second version of the lattice cell of the given configuration can have a second behavior adjustment structure different from the first behavior adjustment structure, and so forth.

The measurement data 612 can include measurements of multiple lattice structures with the corresponding different behavior adjustment structures. The measurements in the measurement data 612 are correlated to respective different input stimuli, such as forces applied to the multiple lattice structures.

The measurements correlated to the different input stimuli are provided as part of the training data set 604, which is used to train the machine learning model 602. Based on the training data set 604, the machine learning model 602 can learn behaviors of different lattice structures formed using lattice cells with different behavior adjustment structures.

Alternatively or additionally, the training data set 604 can include the simulation data 610. The simulation data 610 is produced by running simulations (using simulation programs) of different lattice structures with different behavior adjustment structures. The simulations can produce simulated measured behaviors (e.g., displacements) of the lattice structures, which are correlated to respective different input stimuli.

Once the machine learning model 602 is trained, the machine learning model 602 can be used to generate a recommended lattice cell for a given target modified behavior of a lattice cell. The given target modified behavior and an initial lattice cell is provided as input information 614 to the machine learning model 602. Based on the input information 614, the machine learning model 602 generates a modified lattice cell 616 with an added behavior adjustment structure that the machine learning model 602 has learned will satisfy the given target modified behavior of the input information 614.

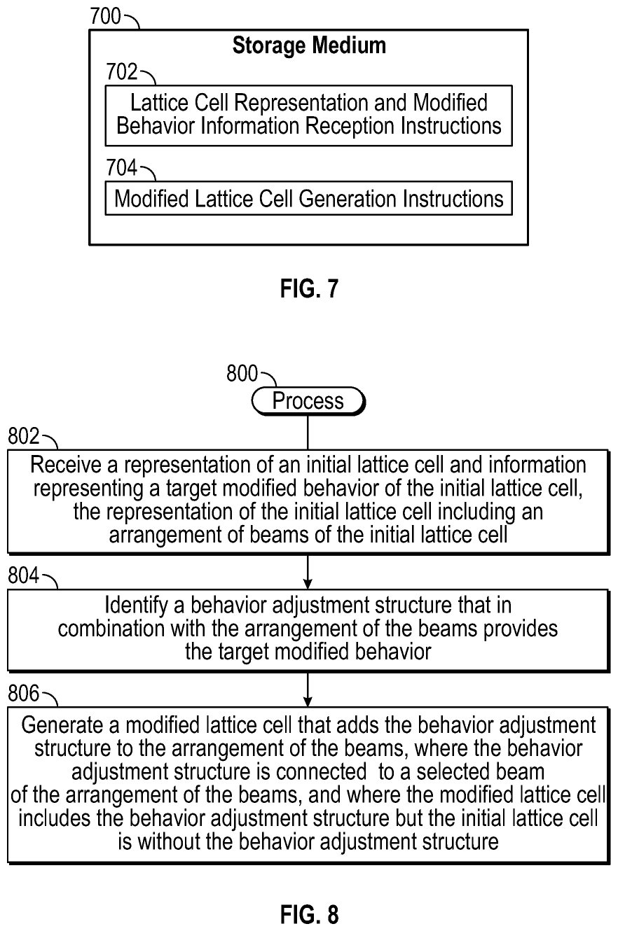

FIG. 7 is a block diagram of a non-transitory machine-readable or

computer-readable storage medium 700 storing machine-readable instructions that upon execution cause a system (e.g., a computer or multiple computers) to perform various tasks.

The machine-readable instructions include lattice cell representation and modified behavior information reception instructions 702 to receive a representation of a lattice cell and information representing a target modified behavior of the lattice cell. The representation of the lattice cell includes an arrangement of beams of the lattice cell.

The machine-readable instructions include modified lattice cell generation instructions 704 to generate a modified lattice cell based on the representation of the lattice cell and the information, where the modified lattice cell includes the arrangement of the beams and an added behavior adjustment structure that is connected to a selected beam of the arrangement of the beams.

In some examples, the information representing the target modified behavior of the lattice cell includes a profile (e.g., a force profile) that correlates a parameter representing an input stimulus (e.g., force) applied on the modified lattice cell to a mechanical property (e.g., displacement) of the modified lattice cell.

In some examples, the target modified behavior of the lattice cell has discrete segments that correspond to respective different input stimulus-mechanical property relationships.

In some examples, the generating of the modified lattice cell uses a program that receives as inputs the representation of the lattice cell and information representing a behavior of a lattice structure built using the lattice cell.

In some examples, the program is to present a GUI (e.g., 408 in FIG. 4) to display a graphical representation of the information (e.g., the curve 410 in FIG. 4). The program is to receive, in the GUI, a user manipulation of the information and to generate the information representing the target modified behavior in response to the user manipulation.

In some examples, the added behavior adjustment structure is spaced apart from a first beam of the arrangement of the beams when the modified lattice cell is in a first physical state, and the added behavior adjustment structure engages the first beam when the modified lattice cell is in a different second physical state (e.g., after compression of the modified lattice cell).

In some examples, the first physical state and the second physical state are different compression states of the modified lattice cell.

In some examples, the added behavior adjustment structure (e.g., the curve plate 210 of FIG. 2B) includes connection points to a first beam and a second beam of the arrangement of the beams, and a protruding portion that engages with a third beam of the arrangement of the beams upon displacement of the first beam and the second beam relative to the third beam.

In some examples, the generating of the modified lattice cell is based on a machine learning model trained using simulations of lattice cells.

In some examples, the generating of the modified lattice cell is based on a machine learning model trained using measurements of mechanical properties of lattice structures built by an additive manufacturing machine based on respective different lattice cells.

In some examples, the generating of the modified lattice cell is based on a machine learning model trained using information of different lattice cells including respective different behavior adjustment structures.

FIG. 8 is a flow diagram of a process 800 according to some examples, which can be performed by the lattice cell modification engine 102, for example.

The process 800 includes receiving (at 802) a representation of an initial lattice cell and information representing a target modified behavior of the initial lattice cell, the representation of the initial lattice cell including an arrangement of beams of the initial lattice cell.

The process 800 includes identifying (at 804) a behavior adjustment structure that in combination with the arrangement of the beams provides the target modified behavior.

The process 800 includes generating (at 806) a modified lattice cell that adds the behavior adjustment structure to the arrangement of the beams, where the behavior adjustment structure is connected to a selected beam of the arrangement of the beams, and where the modified lattice cell includes the behavior adjustment structure but the initial lattice cell is without the behavior adjustment structure.

A storage medium (e.g., 700 in FIG. 7) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

The machine-readable instructions are executable on a hardware processor. A hardware processor can include a microprocessor, a core of a multi-core microprocessor, a microcontroller, a programmable integrated circuit, a programmable gate array, or another hardware processing circuit.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive a representation of a lattice cell and information representing a target modified behavior of the lattice cell, the representation of the lattice cell including an arrangement of beams of the lattice cell; and
generate a modified lattice cell based on the representation of the lattice cell and the information, wherein the modified lattice cell includes the arrangement of the beams and an added behavior adjustment structure that is connected to a selected beam of the arrangement of the beams.

2. The non-transitory machine-readable storage medium of claim 1, wherein the information representing the target modified behavior of the lattice cell comprises a profile that correlates a parameter representing an input stimulus applied on the modified lattice cell to a mechanical property of the modified lattice cell.

3. The non-transitory machine-readable storage medium of claim 2, wherein the target modified behavior of the lattice cell has discrete segments that correspond to respective different input stimulus-mechanical property relationships.

4. The non-transitory machine-readable storage medium of claim 1, wherein the generating of the modified lattice cell uses a program that receives as inputs the representation of the lattice cell and information representing a behavior of a lattice structure built using the lattice cell.

5. The non-transitory machine-readable storage medium of claim 4, wherein the program is to present a graphical user interface (GUI) to display a graphical representation of the information, and wherein the program is to receive, in the GUI, a user manipulation of the information and to generate the information representing the target modified behavior in response to the user manipulation.

6. The non-transitory machine-readable storage medium of claim 1, wherein the added behavior adjustment structure is spaced apart from a first beam of the arrangement of the beams when the modified lattice cell is in a first physical state, and the added behavior adjustment structure engages the first beam when the modified lattice cell is in a different second physical state.

7. The non-transitory machine-readable storage medium of claim 6, wherein the first physical state and the second physical state are different compression states of the modified lattice cell.

8. The non-transitory machine-readable storage medium of claim 1, wherein the added behavior adjustment structure comprises:
connection points to a first beam and a second beam of the arrangement of the beams, and
a protruding portion that engages with a third beam of the arrangement of the beams upon displacement of the first beam and the second beam relative to the third beam.

9. The non-transitory machine-readable storage medium of claim 1, wherein the generating of the modified lattice cell is based on a machine learning model trained using simulations of lattice cells.

10. The non-transitory machine-readable storage medium of claim 1, wherein the generating of the modified lattice cell is based on a machine learning model trained using measurements of mechanical properties of lattice structures built by an additive manufacturing machine based on respective different lattice cells.

11. The non-transitory machine-readable storage medium of claim 1, wherein the generating of the modified lattice cell is based on a machine learning model trained using information of different lattice cells including respective different behavior adjustment structures.

12. A method performed by a system comprising a hardware processor, comprising:
receiving, by a lattice cell modification engine, a representation of an initial lattice cell and information representing a target modified behavior of the initial lattice cell, the representation of the initial lattice cell including an arrangement of beams of the initial lattice cell;
identifying, by the lattice cell modification engine, a behavior adjustment structure that in combination with the arrangement of the beams provides the target modified behavior; and
generating, by the lattice cell modification engine, a modified lattice cell that adds the behavior adjustment structure to the arrangement of the beams, wherein the behavior adjustment structure is connected to a selected beam of the arrangement of the beams, and wherein the modified lattice cell includes the behavior adjustment structure but the initial lattice cell is without the behavior adjustment structure.

13. The method of claim 12, further comprising:
outputting, by the lattice cell modification engine, the modified lattice cell for building a lattice structure including a pattern of the modified lattice cells by an additive manufacturing machine.

14. A lattice structure formed using an additive manufacturing process, comprising:
a pattern of lattice cells, each lattice cell of the pattern of lattice cells comprising an arrangement of interconnected beams and an added behavior adjustment structure connected to selected beams of the arrangement of the interconnected beams,
wherein the arrangement of the interconnected beams is based on a representation of an initial lattice cell that is without the added behavior adjustment structure, and
wherein the added behavior adjustment structure is based on information representing a target modified behavior of the initial lattice cell.

15. The lattice structure of claim 14, wherein the added behavior adjustment structure is spaced apart from a first beam of the arrangement of the beams when the arrangement of the beams is in a first physical state, and the added behavior adjustment structure engages the first beam when the arrangement of the beams is in a different second physical state.
